(19) United States
(12) Patent Application Publication
(10) Pub. No.: US 2018/0035639 A1
(43) Pub. Date: Feb. 8, 2018

(54) APPLICATOR FOR ANIMAL IDENTIFICATION TAGS

(71) Applicant: Shearwell Data Limited, Minehead, Somerset (GB)

(72) Inventors: Richard WEBBER, Minehead, Somerset (GB); Michael FLETCHER, Minehead, Somerset (GB); Melvin VICKERY, Minehead, Somerset (GB); David BROWN, Minehead, Somerset (GB)

(21) Appl. No.: 15/549,600

(22) PCT Filed: Feb. 5, 2016
(86) PCT No.: PCT/EP2016/052576

§ 371 Date: Aug. 8, 2017

(30) Foreign Application Priority Data
Feb. 9, 2015 (GB) 1502120.7

(51) Int. Cl. A01K 11/00

(52) U.S. Cl. CPC A01K 11/002

(57) ABSTRACT

An applicator for animal identification tags comprises a tag magazine receiver configured to receive a tag magazine comprising a reservoir for holding a plurality of discrete animal identification tags, each comprising a male and female engagement portion, and an opening, wherein the identification tags are displaceable along the reservoir to be sequentially dispensed through the opening. A pair of jaws engage male and female portions of a dispensed identification tag through the ear of an animal placed between the jaws. A motorized tag dispenser displaces the identification tags along the reservoir of a received tag magazine to sequentially dispense the identification tags through the opening. A sensor senses information indicative that an identification tag has been dispensed through the opening and received by the pair of jaws. A controller stops operation of the motorized tag dispenser based on an output of the sensor.

### FIELD OF THE INVENTION

The present invention relates to an applicator for animal identification tags.

### BACKGROUND OF THE INVENTION

It is well known in the field of animal identification to provide an identification tag, typically attached to the animal's ear. Such tags may comprise two parts (such as a male and female part) which interlock with one part passing through the animal's ear. Alternatively a tag may be formed with a flexible connection between the two interlocking parts, i.e. as a single unit.

In order to attach tags to an animal, an applicator is used which typically drives a spiked male part of the tag through the animal's ear to engage with a female part of the tag on the other side to securely affix the tag to the animal.

Many applicators used to apply tags to animals only accept one tag and must be re-loaded after each tag is applied to the animal. This is time consuming and can be intricate or awkward to perform and may result in loss of tags if they are dropped while the user is trying to load a new tag into the applicator.

Some applicators are known which feed strips of interconnected tags into the applicator and incorporate a reloading mechanism to feed tags sequentially to the applicator jaws to be applied to an animal. Such applicators typically include a cutting device to sever the front tag from the strip of tags before it is applied to an animal. Such applicators have had some success but are limited by the strips of tags that are supplied for application. The user has no choice about the tag sequence and, if a different type of tag is desired, the whole strip must be changed. These applicators are also mechanically quite complex because a severing device must be provided and timed to cut the front tag from a strip of tags before application to an animal.

In some situations, it is desirable to apply a plurality of different tags to the same animal. For example, it may be desirable to apply a tag comprising an electronic identification device and a separate tag allowing visual identification. Both types of tags are known in the art. For example, electronic identification tags are described in EP 1530417.

It is common in livestock farming to tag different groups of animals with visually distinct tags so that they can be easily separated or sorted (a process known as “drafting”) by visually identifying the group to which the animal belongs (based on its tag) and sorting it accordingly.

In some countries or regions, there may be restrictions (e.g. legislative restrictions) on the exact nature (e.g. colour, shape, size, markings etc.) of particular tags, especially electronic identification tags. For example electronic identification tags may be required to have a particular colour. Such uniformity of identification tags makes it difficult to visually identify different animals or groups of animals and hence to visually sort animals into groups or sub-groups. To overcome such difficulty, it is known to attach a second identification tag which has few or no restrictions on its nature and hence can be visually distinct according to the particular group or sub-group of the animal. This allows electronic identification (using the electronic tag with restrictions on its particular form) and also easy visual identification to allow manual sorting of livestock according to visually distinct identification tags.

The application of two different tags to the same animal is not straightforward with some existing applicator devices. In the case of the single-tag applicator, the tags must be individually loaded into the applicator and the user must select a first type of tag (e.g. an electronic tag) followed by a second type of tag (e.g. a visual identification tag) and apply each separately. In the case of the applicator which is loaded with a strip of tags, either the strip of tags must be changed between applying the first tag (e.g. an electronic tag) and the second tag (e.g. a visual identification tag), or two different applicators must be used, one loaded with the first type of tag (e.g. electronic tags) and the other with the second type of tag (e.g. visual identification tags). None of these situations is satisfactory in terms of efficiency or ease of use.

WO2011/007150, which is a previous application by the present applicant, the disclosure of which is incorporated herein by reference, discloses an alternative applicator system that addresses many of these problems. The applicator system disclosed in WO2011/007150 comprises an applicator and a removable magazine that is, or can be, loaded with individual identification tags. The magazine has an elongate channel for holding identification tags, each comprising a male and female engagement portion. The elongate channel terminates in a front opening of the magazine through which the identification tags can be dispensed. The magazine can be removably connected to the applicator via a magazine receiver apparatus of the applicator so that the front opening of the magazine is positioned adjacent a set of jaws of the applicator. The jaws are configured, upon actuation by squeezing of a trigger handle, to engage the male and female portions of a tag received from the front opening of the magazine through the ear of an animal placed between the jaws.

When the magazine is attached to the applicator body, the identification tags in the elongate channel of the magazine are urged towards the front opening of the magazine by a spring-loaded follower piston of the applicator that is received in the elongate channel of the magazine and that pushes the identification tags along the elongate channel towards the front opening. The identification tags, which are biased towards the set of jaws, are prevented from advancing from the magazine into the jaws by a stop pin. This stop pin is temporarily retracted following actuation of the set of jaws by squeezing of the trigger to enable a single identification tag to advance into the jaws ready for application upon a further actuation of the set of jaws. Thus, individual identification tags are sequentially supplied from the magazine to the set of jaws.

The applicator system disclosed in WO2011/007150 has an advantage that the tag magazine can be pre-loaded with any sequence of different types of discrete identification tag, for example alternating between an electronic type of identification tag and a non-electronic visual type of identification tag. Thus, the applicator system can be used to quickly and efficiently apply different types of identification tags to animals without requiring changing of the tag magazine or loading of individual tags into the apparatus.

### SUMMARY OF THE INVENTION

The present inventors have realised that improvements can be made to the applicator system disclosed in WO2011/007150. In particular, the present inventors have realised that the ease of use and/or efficiency of use of the applicator system disclosed in WO2011/007150 can be improved by motorising one or more parts of the applicator system, so that minimal effort is required from an operator of the applicator system to apply animal identification tags to animals.

At its most general, the present invention relates to an applicator for animal identification tags in which dispensing of individual identification tags from the magazine to the jaws is achieved by: a motorised dispenser that is actuated to dispense identification tags from the magazine to the jaws of the actuator; a sensor for sensing information indicative that an identification tag has been successfully dispensed from the magazine to the jaws of the applicator; and a controller for stopping operation of the motorised dispenser when it is determined that an identification tag has been successfully dispensed from the magazine to the jaws of the actuator.

According to an aspect of the present invention there is provided an applicator for animal identification tags comprising:

a tag magazine receiver configured to receive a tag magazine, the tag magazine comprising a reservoir for holding a plurality of discrete animal identification tags, each comprising a male and female engagement portion, and an opening, wherein the identification tags are displaceable along the reservoir to be sequentially dispensed through the opening;

a pair of jaws arranged to receive an identification tag dispensed from the opening of a received tag magazine, wherein the pair of jaws are operable to engage the male and female portions of the identification tag through the ear of an animal placed between the jaws;

a motorised tag dispenser operable to displace the identification tags along the reservoir of a received tag magazine to sequentially dispense the identification tags through the opening of the received tag magazine;

a sensor for sensing information indicative that an identification tag has been dispensed through the opening of the received tag magazine and received by the pair of jaws; and

a controller configured to stop operation of the motorised tag dispenser based on an output of the sensor.

According to the present invention, the motorised tag dispenser can be operated to displace the identification tags along the reservoir of the received tag magazine so that an identification tag is dispensed from the opening of the received tag magazine and received by the pair of jaws. The successful dispensing of the identification tag from the magazine to the pair of jaws can be determined based on the information sensed by the sensor. Operation of the motorised tag dispenser can then be stopped by the controller based on an output of the sensor, so that the motorised tag dispenser is stopped from attempting to further displace the identification tags when an identification tag has been successfully supplied to the pair of jaws.

Thus, with the present invention the pair of jaws can be reliably, efficiently and automatically supplied with an individual identification tag in preparation for each actuation of the pair of jaws. Thus, the ease of use and efficiency of use of the applicator in applying identification tags to multiple animals is improved.

The present invention according to the first aspect may have any one, or, to the extent that they are compatible, any combination of the following optional features.

The controller may be part of the motorised tag dispenser. Alternatively, the controller may be part of the sensor, or a separate part of the applicator.

The reservoir of the magazine may be an elongate channel. The magazine may comprise an elongate member having an elongate channel in which the identification tags are received. One end of the elongate channel may terminate in the opening, which may be at a front end of the magazine, so that identification tags can be dispensed through the opening by displacing them along the channel through the opening. Such a channel may be about the width of a single identification tag and is typically not wide enough for two identification tags to be arranged side by side. This results in the identification tags being arranged in a single file in the reservoir. The channel may be substantially straight, or alternatively the channel may be curved. However, if the channel has too great a curvature, the tags may not feed smoothly along it causing a failure in the supply of tags to the dispensing opening.

Information indicative that an identification tag has been dispensed through the opening of the received tag magazine and received by the pair of jaws may mean any information that makes it possible to determine or identify that an identification tag has been dispensed through the opening of the received tag magazine and received by the pair of jaws.

The pair of jaws may define a tag dispensing opening into which an ear of an animal can be inserted. The jaws may be actuated by the user actuating a trigger, for example a handle, foot pedal or button, which, when actuated, causes a tag which is situated in the dispensing opening to be connected across the dispensing opening, e.g. by causing a male part of the tag to be driven across the opening to engage with a female part on the opposite side. When an animal's ear is inserted in the dispensing opening, this dispensing motion securely affixes the tag to the animal, e.g. by driving a spiked male portion of the tag through the ear and engaging it with a female portion of the tag on the other side of the ear.

The controller may comprise an electronic circuit board in the applicator. The controller may comprise a processor. For example, the controller may comprise a processor in wired communication with the motorised tag dispenser for controlling the operation of the motorised tag dispenser, i.e. in wired communication with a motor of the motorised tag dispenser.

The sensor may be for sensing information indicative of the displacement of the identification tags along the reservoir of the received tag magazine. Since the configuration of the tag magazine and the jaws is fixed once the tag magazine is received on the tag magazine receiver, a fixed displacement is required to displace an identification tag in the tag magazine adjacent the opening so that it is dispensed from the opening and received by the pair of jaws. Therefore, by sensing information indicative of the displacement of the identification tags along the reservoir, it is possible to determine whether or not the identification tags have been displaced a sufficient amount for an identification tag to have been dispensed through the opening and received by the pair of jaws.

Information indicative of the displacement of the identification tags along the reservoir of the received tag magazine may mean any information that makes it possible to determine or identify an amount of displacement of the identification tags along the reservoir.

The motorised tag dispenser may comprise a tag dispenser motor for actuating the motorised tag dispenser. Preferably the tag dispenser motor is an electric motor, in which case the applicator may comprise a power supply for powering the electric motor. For example, the applicator may comprise one or more batteries arranged to power the tag dispenser motor. This has an advantage of making the applicator portable, which is advantageous in many environments in which such an applicator may be used. Alternatively, the actuator may be connectable to an external power supply, for example through a power cable. The controller may be part of the tag dispenser motor.

Stopping operation of the motorised tag dispenser based on an output of the sensor may comprise stopping operation of the tag dispenser motor, i.e. stopping the tag dispenser motor from running or moving.

The motorised tag dispenser may act to push the identification tags along the reservoir of the received tag magazine. For example, the motorised tag dispenser may comprise a pusher arranged to be received in the reservoir of a received tag magazine, the pusher being displaceable along the reservoir to push the identification tags along the reservoir, and the tag dispenser motor may be operable to displace the pusher along the reservoir. The pusher may therefore act as a follower piston, which can run along the length of the reservoir to push the identification tags along the reservoir.

The pusher may be arranged to be received in a second opening of the reservoir of the tag magazine when the tag magazine is received by the tag magazine receiver. For example, where the tag magazine has an elongate channel, the opening for dispensing identification tags may be located at a first (front) end of the elongate channel and the second opening for receiving the pusher may be located at a second (rear) end of the elongate channel. The pusher may be configured to be able to travel along an entire length of the reservoir of the magazine, so that all of the identification tags in the magazine can be dispensed.

Of course, in other embodiments the motorised tag dispenser may instead act to pull the identification tags along the reservoir.

The motorised tag dispenser may further comprise a lead-screw, the tag dispenser motor may be arranged to rotate the lead-screw, and the pusher may be coupled to the lead-screw so that rotation of the lead-screw causes displacement of the pusher along the reservoir. Thus, the tag dispenser motor can be operated to displace the pusher along the reservoir to push identification tags along the reservoir by the tag dispenser motor rotating the lead-screw. Advantageously, the pusher may also be able to be moved in the opposite direction (away from the opening of the magazine for dispensing identification tags) by the motor being operated to rotate the lead-screw in the opposite direction. This may be useful when re-setting the applicator ready for receipt of a new tag magazine when all of the identification tags in a tag magazine have been dispensed.

The pusher may be coupled to the lead-screw by having a part with an internal screw thread that is threaded on to an external-screw thread of the lead-screw, the pusher being prevented from rotating with the lead-screw so that rotation of the lead-screw causes linear displacement of the pusher.

Alternatively, the pusher may be coupled to the lead-screw by having a part with an external screw-thread that is threadedly engaged with an external screw-thread of the lead-screw.

A lead-screw may be any elongate externally threaded rod or member.

The sensor may be configured to sense information indicative of the displacement of the pusher along the reservoir of the tag magazine. Since the pusher is pushing the identification tags along the tag magazine, the displacement of the identification tags should be the same as the displacement of the pusher. Thus, by sensing information indicative of the displacement of the pusher, it is possible to determine information relating to the displacement of the identification tags.

The sensor may be configured to sense a displacement of the pusher, i.e. an absolute value of the extent of displacement of the pusher.

Alternatively, the sensor may be configured to sense information indicative of a position of the pusher. For example, certain positions of the pusher may correspond to displacements of the identification tags at which an identification tag is dispensed from the opening of the tag magazine and received by the pair of jaws.

The sensor may be configured to sense a position of the pusher. By sensing the position of the pusher, it may be possible to determine how far the pusher has moved, or whether the pusher is at a position at which an identification tag is dispensed from the opening.

Of course, there may be more than one sensor, and the outputs of one or more of these sensors may be used to determine if and when the identification tags have been displaced by an appropriate amount. For example, there may be a plurality of different sensors for sensing different positions of the pusher/identification tags as they are displaced along the reservoir.

The tag magazine receiver may comprise an elongate member configured to receive the tag magazine. For example, where the tag magazine has an elongate member, the tag magazine receiver may also comprise an elongate member and the elongate tag magazine may be mounted on, or in, the elongate tag magazine receiver. For example, the elongate member may comprises a channel for receiving the tag magazine therein.

The pair of jaws may be adjacent one end of the tag magazine receiver, so that identification tags dispensed from the magazine are directly received by the jaw. Where the applicator comprises a pusher, a starting position of the pusher may be at an opposite end of the tag magazine receiver.

The applicator may comprise a plurality of sensors, for sensing information indicative that an identification tag has been dispensed through the opening of the received tag magazine and received by the pair of jaws, arranged along an elongate length of the elongate member. For example, each of the sensors may be for sensing a position or a displacement of the identification tags or of the pusher, where the applicator comprises the pusher.

The applicator may comprise a plurality of sensors, for sensing information indicative that an identification tag has been dispensed through the opening of the received tag magazine and received by the pair of jaws, disposed so as to be arranged along a length of the reservoir of a received tag magazine. For example, each of the sensors may be for sensing a position or a displacement of the identification tags or of the pusher, where the applicator comprises the pusher.

The sensors may be provided along a printed circuit board, for example a single printed circuit board. The processor. Alternatively, the controller may be separate to the printed circuit board. The printed circuit board may be disposed so as to be beneath a received magazine and to extend along substantially the entire length of the received magazine.

The sensors may be arranged at a predetermined spacing that is equal to a necessary displacement of the identification tags to dispense an identification tag from the opening of the received tag magazine so that it is received by the pair of jaws.

Each of the sensors may be configured to detect when the pusher is proximal to the sensor. Thus, where the sensors are arranged at the predetermined spacing, each time a sensor detects the pusher, the pusher, and thus the identification tags, have been displaced along the reservoir by the predetermined spacing, and thus it can be identified that an identification tag has been dispensed from the opening and received by the pair of jaws. The first sensor of the plurality of sensors may be positioned one predetermined spacing away from a predetermined initial start point of the pusher when a tag reservoir is received by the tag reservoir receiver.

The pusher may comprise a magnet and the sensors may be configured to detect the magnet when the pusher is proximal to the sensor. Thus, the sensors are able to detect when the pusher is proximal to the sensor. The strength of the magnet, and/or the sensitivity of the sensors, may be configured so that only one sensor at a time can detect the magnet. Alternatively, a sensor may be said to detect the pusher only when an output of the sensor is above a certain threshold value.

The controller may be configured to stop operation of the motorised tag dispenser when one of the sensors detects that the pusher is proximal to the sensor. As mentioned above, detection that the pusher is proximal to the sensor may indicate that the identification tags have been displaced a sufficient amount for an identification tag to be dispensed from the opening and received by the jaws. Thus, operation of the motorised tag dispenser is automatically stopped when an identification tag is dispensed from the opening, so that the motorised tag dispenser no longer attempts to displace the identification tags along the reservoir.

Of course, in other embodiments the configuration of the sensors and the magnet may be reversed, so that a sensor is provided on the pusher and magnets are provided at the predetermined spacing. The other details may be as described above.

The applicator may comprise a motorised jaw operator for operating the pair of jaws to engage the male and female portions of the identification tag through the ear of an animal placed between the jaws.

The motorised jaw operator may be an actuator for causing the jaws to close.

The motorised jaw operator may comprise a jaw operator motor for actuating the motorised jaw operator. The jaw operator motor may be an electric motor. The jaw operator motor may be a different motor to the tag dispenser motor. In other words, the applicator may comprise at least two motors, one for actuating the tag dispenser and one for actuating the jaw operator.

The applicator may comprise a jaw sensor for sensing information indicative that the pair of jaws has been operated/closed to engage the male and female portions of the identification tag through the ear of an animal placed between the jaws.

For example, the information may be information indicating that the pair of jaws have been caused to close, or are currently closed. Alternatively, the information may be information indicating that the pair of jaws has re-opened after being caused to close, or are currently open.

The jaw sensor may be configured to sense when the pair of jaws have re-opened following being closed. In this configuration, the pair of jaws are ready to receive an identification tag from the magazine.

The applicator may comprise a controller configured to stop operation of the motorised jaw operator based on an output of the jaw sensor. The controller may comprise a printed circuit board. The controller may comprise a processor. The controller may be the same controller as the controller for stopping the operation of the motorised tag dispenser. Alternatively, it may be a different, separate controller, which may be in communication with the first controller. The controller may be part of the jaw sensor, or part of the jaw operator motor, or a separate part of the applicator.

Stopping operation of the motorised jaw operator may comprise stopping operation of the jaw operator motor.

Thus, by stopping the operation of the motorised jaw controller after operation of the jaws, the motorised jaw controller can be prevented from continuing to force the jaws together after they have closed, or from inadvertently causing the jaws to close again after they have opened.

The jaw sensor may comprise a magnetically energised sensor for sensing when a magnet is proximal to the sensor. For example, the sensor may be brought into close proximity with the magnet when the jaws are brought together, so that the sensor senses that the jaws have been brought together. Alternatively, the sensor may be brought into close proximity with the magnet when the jaws are opened after being closed, so that the sensor senses that the jaws have been operated but are now open. The controller may be configured to stop operation of the motorised jaw controller when the sensor detects that the magnet is proximal to the sensor.

One of the pair of jaws may have a magnet, and the jaw sensor may be positioned on a housing of the applicator so that the magnet and the jaw sensor are brought into proximity when the pair of jaws are open. Thus, the sensor is able to sense when the jaws are open following operation of the jaws and are ready to receive an(other) identification tag for applying to an ear of an animal.

The motorised jaw operator may comprise: a rotatable cam arranged to engage with an arm of one of the pair of jaws to force the pair of jaws to close as the cam is rotated, and to disengage from the arm upon further rotation of the cam; and a jaw operator motor operatively coupled to the rotatable cam and operable to rotate the cam.

Thus, the jaw operator motor can be operated to cause the pair of jaws to close by causing the cam to rotate. Further rotation of the cam by the motor then has no effect on the operation of the jaws because the cam disengages from the arm. This arrangement means it is not necessary to stop the jaw operator motor immediately upon closing of the jaws, so the time constraints on the stopping of the jaw operator motor are less severe. For example, the jaw operator motor can instead by stopped a short time after the jaws have closed, or when the jaws have reopened again after closing. The jaws may be biased apart, for example by a spring, so that they automatically reopen after closing once the cam has disengaged from the arm.

The applicator may comprise a trigger for causing the motorised jaw operator to operate the pair of jaws when the trigger is actuated by a user of the applicator. For example, the trigger may be a button or a lever. Thus, when the user activates the trigger, the jaw operator motor may start operation to cause the jaws to close so as to apply an identification tag in the jaws. The first time the applicator is operated after receiving a new tag magazine there is no identification tag in the pair of jaws. Therefore, the jaw operator motor may operate the pair of jaws to close without the jaws applying an identification tag, because there is no identification tag in the jaws.

The motorised tag dispenser may be configured to start operation after an end of operation of the motorised jaw operator. For example, the jaw sensor may detect that the jaws are open after operation of the jaws and thus are able to receive a (new) identification tag. The motorised tag dispenser may be configured to start operation to start displacing identification tags along the reservoir of the magazine to dispense an identification tag from the magazine to be received by the jaws when the jaw sensor detects that the jaws have reopened. For example, the controller for controlling the operation of the motorised tag dispenser may be configured to control the motorised tag dispenser to start in this situation. As discussed above, the controller for controlling the operation of the motorised tag dispenser may be the same as the controller for controlling the operation of the motorised jaw controller, and thus may receive the output of the jaw sensor. For example, they may be the same processor in communication with both the tag dispenser motor and the jaw operator motor. Alternatively, there may be two separate controllers (e.g. two separate processors) in communication with each other.

The motorised tag dispenser may be configured to start operation a predetermined time after an end of operation of the motorised jaw operator.

The pair of jaws may be biased apart, for example by a spring. Thus, the jaws may automatically re-open after being closed.

The controller may be configured to operate the tag dispenser motor to displace the pusher back to an initial position when all of the identification tags have been dispensed from the opening of a received tag magazine. For example, this may happen automatically if the trigger of the applicator is pressed by the user and there are no identification tags in the reservoir.

There may be provided an applicator system for animal identification tags comprising the applicator according to the first aspect of the present invention, optionally with one or more of the optional features discussed above, and a tag magazine, the tag magazine comprising a reservoir for holding a plurality of discrete animal identification tags, each comprising a male and female engagement portion, and an opening, wherein the identification tags are displaceable along the reservoir to be sequentially dispensed through the opening.

The tag magazine may be received by the tag magazine receiver with the opening adjacent the pair of jaws.

The tag magazine may be loaded with plural discrete identification tags.

The reservoir of the tag magazine may comprise a channel.

The magazine may accept either one-part tags (having a male engagement portion and a female engagement portion joined together by a flexible connecting portion). The magazine may be adapted to accept elongate one-part tags having a male engagement portion at one end and a female engagement portion at the other end with a flexible connecting portion between them. When such tags are applied to the ear of an animal, the male portion passes through the ear and engages with the female portion on the other side with the elongate connecting portion extending around the edge of the ear. The tags may have a resilient elongate connecting portion between the male portion and female portion of the tag, for the reasons discussed below.

When loaded into the magazine, the elongate tags may be held in a folded position by the dimensions of the magazine, typically by the dimensions of the reservoir of the magazine. The identification tags may be folded such that the male engagement portion and the female engagement portion are opposed to each other along their axis of engagement (although they are not actually engaged). The identification tags may be held substantially in a “D-shape” configuration with a stem of the male portion of the tag forming the upright section of the D-shape and the elongate portion forming the curved section of the D-shape. The elongate portion of the tags may be flat prior to loading into the magazine and, as mentioned previously, may be resilient. Hence, when the tags are loaded in a bent arrangement in the magazine, they may be biased towards an open, flat, position. This means that the two legs of the tags (each carrying one of the male or female portions of the tag) are trying to splay apart but are being restrained from doing so by the dimensions of the magazine reservoir.

Where the reservoir is an elongate channel, and when the tags are pushed towards the front opening of the magazine, this bent (or D-shaped) arrangement of the tags means that the tags simply abut each other (e.g. the curved portion of one bent tag abuts the straight stem of a male portion of the adjacent tag) rather than stacking protruding into each other as they might if they were folded over to a lesser extent, e.g. in a V- or U-shape. Although the stacking of tags folded into a V- or U-shape may be more space efficient because the shapes can interlock, it can result in feeding problems in the magazine because the individual tags can become entangled, e.g. the male part of such tags often includes a spike portion with a shoulder which can catch on an adjacent tag if they are folded into a U- or V-shape and stacked interlocking each other. Such unwanted snaring of adjacent tags impairs the smooth dispensing of individual tags from the magazine. Such snaring may be avoided by folding the tags into a D-shape so that the male portion of the tag is not exposed and able to catch or snare on adjacent tags.

Where the magazine is an elongate channel, the walls of the channel may define one or more recessed guide channels which may accept one or more protrusions on each tag. This arrangement can be beneficial to guide the tags along the elongate channel towards the front opening of the magazine and to prevent the tags from snaring or catching on each other as they are urged towards the front opening of the magazine. Two opposite walls of the elongate channel of the magazine may each define a guide channel which runs along the length of the elongate channel to accept two guide protrusions on each tag so as to keep the tags in line and running along the same plane and guide them towards the front opening of the magazine.

This ability to load individual tags into the magazine reservoir means that an applicator system can overcome the problems associated with the need to apply two (or more) different tags to an individual animal. The two or more tags do not necessarily need to be the same, they may have a different size, shape, colour, marking or they may optionally include additional, known, identification components such as an electronic identification device. For example, in the situation described above in which it is desired to apply an electronic identification tag and a visual identification tag, such tags could be arranged one after the other in a magazine so as to be sequentially dispensed by the applicator device.

Where the tags are folded in the magazine and are biased towards an open, flat position, when the tags advance out of the magazine dispensing opening towards the jaws, they open out under this bias into a V- or U-shape in a dispensing position (i.e. with the legs of the tag splayed apart) to allow an animal part (such as an ear) to be inserted between the male and female portions of the tag. This allows the advantages of arrangement in a folded state in the magazine (as discussed above) while at the same time, avoiding the need to incorporate a specific mechanism to arrange the tag in the dispensing position in the dispensing opening (because the bias of the tag to try and open itself out drives it naturally into the dispensing position). Each jaw preferably has a tag retaining recess in the surface opposing the other jaw. These tag retaining recesses act as seats for each end of the tag in the face of the jaws and accept the ends of the tag in the dispensing position. Each tag retaining recess may have an abutment at the end of the recess away from the magazine opening against which the ends of the arms of a tag abut in the dispensing position.

Therefore, as a tag advances into the dispensing position, it may engage the abutment in the tag retaining recess of the jaws of the device. This stops the tag in the jaws of the device and prevents it from being driven entirely out of the jaws. The tendency of the legs of the tags to splay apart (due to the resilience of the elongate connecting portion of the tag) ensures that the ends of the tag engage the abutment in the tag retaining recess because the legs of the tag are urged apart and the ends of the legs slide along the respective faces of the jaws before engaging the abutment in the tag retaining recess.

### BRIEF DESCRIPTION OF THE DRAWINGS

Embodiments of the present invention will now be discussed, by way of example only, with reference to the accompanying Figures, in which:

FIG. 1 is an exploded view of an applicator according to a first embodiment of the present invention;

FIG. 2 is a side view of the applicator according to the first embodiment of the present invention;

FIG. 3 is a sectional view of the applicator according to the first embodiment of the present invention;

FIG. 4 is an enlarged rear portion of a loaded tag magazine according to embodiments of the present invention;

FIG. 5 is a side view of a loaded tag magazine according to embodiments of the present invention;

FIG. 6 is a schematic drawing of the printed circuit board of the embodiment shown in FIG. 1;

FIG. 7 is an enlarged view of a rear end of the upper jaw of the embodiment shown in FIG. 1.

### DETAILED DESCRIPTION OF THE PREFERRED EMBODIMENTS AND FURTHER OPTIONAL FEATURES OF THE INVENTION

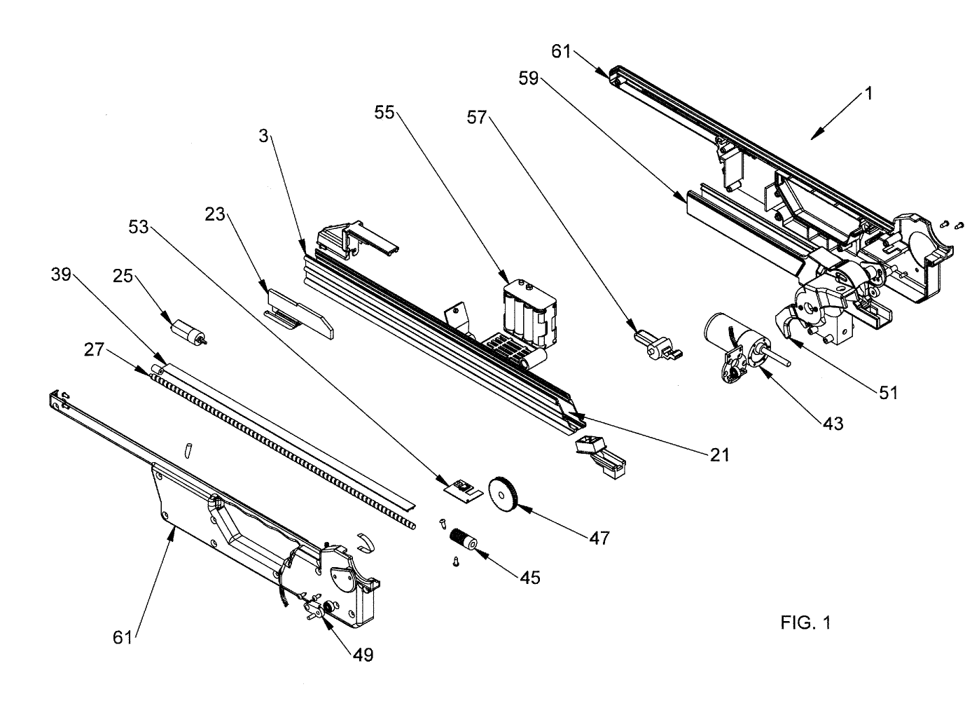

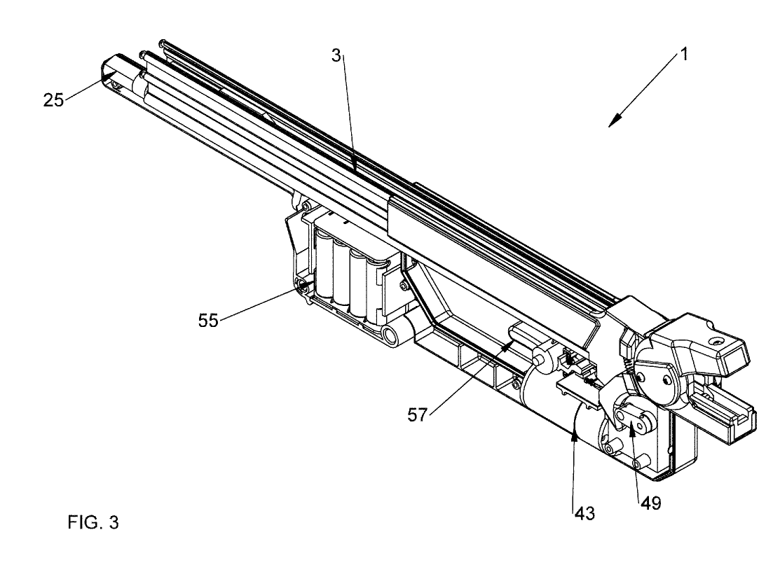

A first embodiment of the present invention will now be discussed with reference to FIGS. 1 to 7.

The applicator according to the first embodiment of the present invention comprises a motorised identification tag feed system for feeding individual identification tags to a pair of jaws for applying the identification tag to an ear of an animal, and a motorised jaw operator system for operating the pair of jaws to apply the identification tag to an ear of an animal.

Both the motorised identification tag feed system and the motorised jaw operator system of the applicator will now be described in detail with reference to FIGS. 1 to 7.

As shown in FIGS. 1 to 3, an applicator 1 according to the first embodiment of the present invention comprises a tag magazine guide 3 (corresponding to a tag magazine receiver in the claims) for receiving a tag magazine 5.

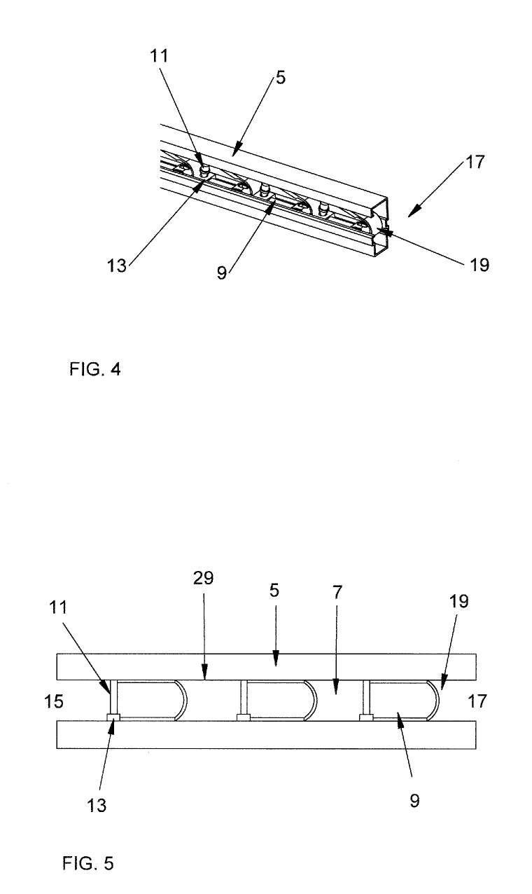

As shown in FIG. 4, which shows an enlarged rear portion of a loaded tag magazine 5, and FIG. 5, which shows a side view of a loaded tag magazine 5, the tag magazine is an elongate rod-like member comprising an elongate channel 7 (corresponding to a reservoir in the claims) for holding a plurality of discrete animal identification tags 9, each of which comprises a male 11 and female 13 engagement portion. The tag magazine 5 further comprises a first opening 15 at a first (front) end thereof, through which the identification tags 9 can be dispensed by displacing them along the channel 7. Furthermore, the tag magazine 5 has a corresponding second opening 17 at a second (rear) end thereof. As discussed in more detail below, the second opening 17 facilitates access to the channel 7 by a pusher for pushing identification tags 9 along the channel 7 towards the first opening 15.

The magazine 5 is loaded with individual animal identification tags 9 which are arranged in a line in the channel 7, which runs the length of the magazine 5 between the first opening 15 and the second opening 17.

As can be seen in FIGS. 4 and 5, the individual identification tags 9 are folded over so that the protruding male portion 11 is touching the female portion 13, although not actually engaged with it. Resilient elongate connecting portions 19 of the identification tags 9 are bent over but are biased (by the resilience of the connecting portion 19) against upper and lower walls of the magazine 5.

A recess is provided in each wall of the magazine 5 to accept a projection on each side of each identification tag 9. These projections may be provided at some point near the female portion 13 of the identification tag 9 or along the sides of the elongate tag portion between the female portion 13 and the bend in the elongate portion 19. These projections run along the recesses and keep the identification tags 9 in a level and controlled position along the channel 7. This may help to prevent the identification tags 9 from catching or snaring on each other in the magazine 5 and causing jams in the tag feed.

The identification tags 9 are shown as being spaced apart in the schematic image of FIG. 5 for reasons of clarity. However, in reality the identification tags 9 are normally in direct contact, particularly when they are displaced along the channel 7 towards the opening 15 as described below. The identification tags 9 are slidable along the channel 7 towards the front opening 15.

As shown in FIG. 1, the tag magazine guide 3 has a guide therein. In use, the tag magazine 5 is received in the guide channel 21 with the first (front) opening 15 adjacent jaws (which are discussed below) of the applicator 1 at a first (front) end of the magazine guide 3, and with the second (rear) opening 17 at an opposite second (rear) end of the magazine guide 3. The guide channel 21 may be configured to releasably attach to the tag magazine 5, or to releasably grip the tag magazine 5, so as to releasably connect the tag magazine 5 to the applicator 1.

A tag pusher 23 is provided at the second (rear) end of the magazine guide 3, at least partially within the guide channel 21. The tag pusher 23 is configured to be received in the channel 7 of the magazine 5 through the second (rear) opening 17 of the magazine 5. The tag pusher 23 may be received in the magazine 5 when the magazine 5 is received in the tag magazine guide 3, i.e. when the magazine 5 is inserted into the guide channel 21. Alternatively, the guide channel 21 may be longer than the tag magazine 5 to provide space for the magazine 5 to be inserted in the guide channel 21 in front of the tag pusher 23, and the tag pusher 23 may then be advanced into the channel 7 of the magazine 5 using the tag pusher displacement system discussed below.

The tag pusher 23 is slidable along the guide channel 21 and within the channel 7 of the magazine 5 so as to push the identification tags 9 along the channel 7 towards the front opening 15.

The tag pusher 23 is part of a motorised tag dispenser that is operable to displace the identification tags 9 along the channel 7 to sequentially dispense the identification tags 9 through the front opening 15 of the tag magazine 5.

The motorised tag dispenser further comprises a tag feed motor 25 and a lead-screw 27 (an elongate externally threaded rod or member). The tag feed motor 25 is configured to rotate the lead-screw 27. For example, the lead-screw 27 may be directly coupled to a rotating shaft of the tag feed motor 25. Thus, operation of the tag feed motor 25 causes rotation of the lead-screw 27. The lead-screw 27 extends substantially along the entire length of the tag magazine guide 3.

It may be possible to operate the tag feed motor 25 in either of two opposite directions, so as to cause rotation of the lead-screw 27 in either of two opposite directions. For example, the tag feed motor 25 may have a rotatable shaft that can be rotated in either a forward or a reverse direction.

The tag pusher 23 is operatively coupled to the lead-screw 27 so that rotation of the lead-screw 27 causes linear displacement of the tag pusher 23 along the guide channel 21 of the tag magazine guide 3, and thus along the channel 7 of a tag magazine 5 received in the tag magazine guide 3. For example, the tag pusher 23 may have a threaded part that is in threaded engagement with an external screw thread of the lead-screw 27 so that rotation of the lead-screw 27 causes linear displacement of the tag pusher 23.

As shown in FIGS. 4 and 5, the tag magazine 5 may have one or more openings 29, for example an elongate slot or window in a side face of the tag magazine 5, through which an operative connection between the tag pusher 23 and the lead-screw is maintained as the tag pusher 23 is displaced along the channel 7 of the tag magazine 5. Preferably, the opening 29 is a slot that extends along substantially an entire length of the tag magazine 5, so that the tag pusher 23 can be displaced along substantially the entire length of the tag magazine 5 to dispense all of the identification tags 9 in the channel 7 of the tag magazine 5. For example, a threaded portion of the tag pusher 23 for threadedly engaging with a screw thread of the lead-screw 27 may protrude from the tag magazine 7 through the opening 29.

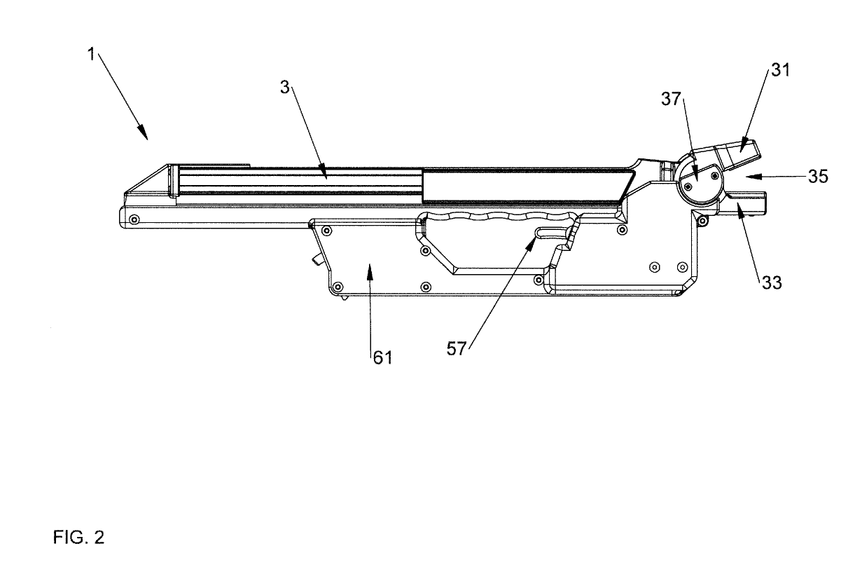

At the opposite first (front) end of the magazine guide 3 are provided a pair of jaws 31, 33 comprising an upper jaw 31 and a lower jaw 33, which define a dispensing opening 35 there-between. As described in more detail below, the pair of jaws 31, 33 are operable to clamp together so as to affix a tag received in the jaws 31, 33 to the ear of an animal which is placed in the dispensing opening 35. A biasing spring is provided to bias the jaws 31, 33 apart to the open configuration shown in FIG. 2. The jaws 31, 33 are pivoted together at a pivot 37, so that they can pivot relative to each other to open and close the jaws 31, 33.

When the tag feed motor 25 is operated to displace the tag pusher 23 along the channel 7 of the tag magazine, the identification tags 9 are displaced along the channel 7 so that an identification tag 9 is received by the pair of jaws 31, 33 ready for applying to the ear of an animal. As an identification tag 9 is dispensed from the dispensing opening 15 of the magazine 5, the identification tag 9 opens out from a position where the male and female parts are touching or almost touching, to one in which arms of the identification tag 9 having the male and female parts are splayed apart. When the jaws 31, 33 are then actuated (as discussed below) the jaws 31, 33 are squeezed together to drive the male part 11 of the identification tag 9 through the ear of an animal which is inserted into the dispensing opening 35 to engage with the female part 13 of the identification tag 9 which is retained in the lower jaw 33 of the applicator 1 to securely fix the identification tag 9 to the ear of the animal.

As shown in FIG. 1, the applicator 1 comprises a printed circuit board 39 that extends along substantially the entire length of the tag magazine guide 3. The printed circuit board is positioned directly below the tag magazine guide 3, so that in use it is directly below the channel 7 of the tag magazine 5 received in the guide channel 21.

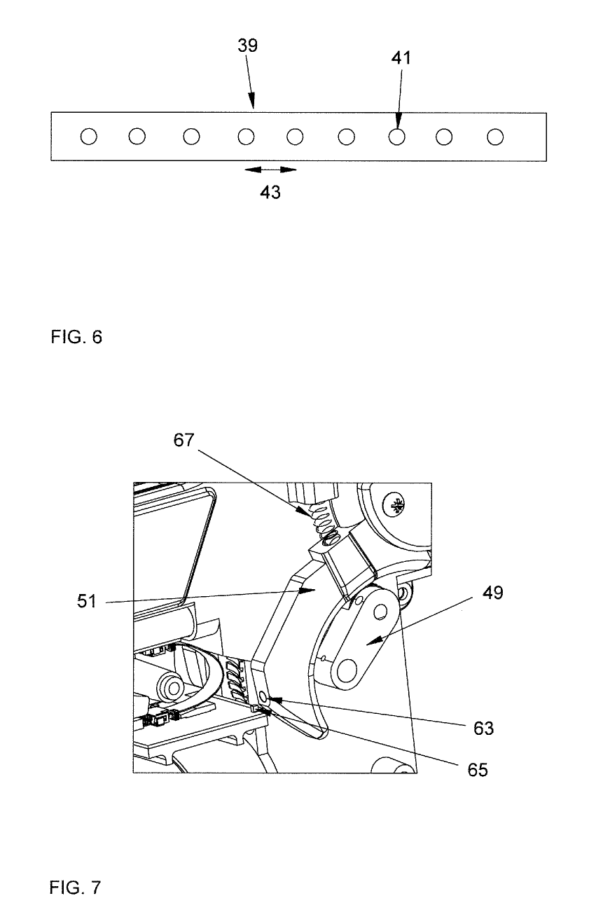

As shown schematically in FIG. 6, the printed circuit board 39 comprises a plurality of sensors 41 arranged along an elongate length of the printed circuit board 39 at a predetermined spacing 43. Thus, in use the sensors 41 are arranged along the length of the channel 7 of the tag magazine 5, and are directly below the tag magazine 5. Each of the sensors 41 is configured to sense when the tag pusher 23 is adjacent to that sensor 41, i.e. when the tag pusher 23 is directly above that sensor 41. For example, the tag pusher 23 may comprise a magnet, or magnetic material, and the sensors 41 may be configured to detect that the tag pusher 23 is proximal to the sensor 23 by detecting the magnetism of the magnet or magnetic material. For example, the sensors 41 may be configured to be energised by the magnet in the tag pusher 23. The sensors may be hall-effect sensors, which are widely known and available.

The predetermined spacing 43 between the sensors corresponds to a predetermined displacement of the identification tags 9 in the channel 7 of the magazine 5 necessary to dispense a single identification tag 9 from the dispensing opening 15 of the magazine 5 so that it is received by the pair of jaws 31, 33 ready for dispensing. For example, where the identification tags 9 are in contact in the channel 7 of the magazine 5, the predetermined spacing 43 may correspond to a length of the identification tags 9 along the channel 7. The first sensor 41 may be positioned at the predetermined spacing 43 from the second (rear) end 17 of the magazine 5, so that when the tag pusher 23 reaches the first sensor the first identification tag 9 has just been dispensed from the front dispensing opening 15 of the magazine 5.

The printed circuit board 39 or the tag feed motor 25 may comprise a controller for stopping the operation of the tag feed motor based on a signal from one of the sensors 41, or from the printed circuit board 41, indicating that the tag pusher 23 is proximal to one of the sensors 41. As discussed above, because of the predetermined spacing 43 of the sensors 41, the positions of the sensors 41 correspond to displacements of the tag pusher 43 along the channel 7 of the reservoir 5 at which an identification tag 9 has been dispensed from the dispensing opening 15 and has been received by the pair of jaws 31, 33. Thus, by stopping the motor when one of the sensors 41 detects that the tag pusher 23 is proximal to the sensor 41, the tag feed motor 23 is stopped immediately after an identification tag 9 is dispensed and received by the jaws 31, 33 ready for applying to the ear of an animal.

The controller may be a processor integral with the printed circuit board 39 or the tag feed motor 25. Alternatively, the controller may be a distinct component from the printed circuit board 39 or the tag feed motor 25. For example, the controller may be a separate processor that is in wired communication with both the printed circuit board 39 (or the sensors 41 thereon) and the tag feed motor 25, so that the processor can control the operation of the tag feed motor 25 based on the output(s) of the sensor(s) 41.

As shown in FIG. 1, the applicator 1 according to the present invention further has a motorised jaw operator for operating the pair of jaws 31, 33 to engage the male 11 and female 13 portions of the identification tag 9 through the ear of an animal placed between the jaws 31, 33. The motorised jaw operator comprises a jaw operator motor 43, a worm 45, a worm-wheel 47, a jaw-closing cam 49 and a jaw arm 51 of the upper jaw 31.

The jaw operator motor 43 is arranged to rotate the worm 45. For example, the worm 45 is connected to a rotatable shaft of the jaw operator motor 43. The worm 45 is a tubular member having a screw thread on the external surface thereof. The worm 45 is arranged to rotate the worm-wheel 47. The worm-wheel 47 is a disk having a thread around the circumference thereof, which corresponds to the thread of the worm 45. The thread of the worm-wheel 47 is engaged with the thread of the worm 45 so that rotation of the worm 45 causes corresponding rotation of the worm-wheel 47. The axis of rotation of the worm-wheel 47 is perpendicular to the axis of rotation of the worm 45. The worm-wheel 47 is coupled to the jaw-closing cam 49 so that rotation of the worm-wheel 47 causes corresponding rotation of the jaw-closing cam 49. Thus, operation of the jaw operator motor 43 causes rotation of the jaw-closing cam 49.

The upper jaw 31 has a jaw arm 51, which is a curved arm that extends in an opposite direction to the upper jaw 31. The jaw-closing cam 49 and the jaw arm 51 are arranged so that the jaw-closing cam 49 engages with the jaw arm 51 over part of the rotation of the jaw-closing cam 49 to displace the jaw arm 51 upwards, and thus displace the upper jaw 31 downwards to close the pair of jaws 31, 33. Thus, operation of the jaw motor 43 causes the pair of jaws 31, 33 to be operated (forced closed), so as to engage the male and female portions of an identification tag 9 received by the pair of jaws 31, 33 through the ear of an animal placed between the jaws 31, 33. Once the pair of jaws 31, 33 is closed, continued rotation of the jaw-closing cam 49 causes the jaw-closing cam 49 to disengage from the jaw arm 51, i.e. when the jaw closing cam 49 is at the bottom part of its rotation in FIG. 1 it is no longer in contact with the jaw arm 51. When this occurs, the jaw operator motor 43 no longer forces the jaws 31, 33 closed.

A spring is provided between the upper jaw 31 and the lower jaw 33 to bias the jaws 31, 33 apart. This spring is compressed when the jaws 31, 33 are forced together by the operation of the jaw operator motor 43. However, once the jaw-closing cam 49 is disengaged from the jaw arm 51, the compressed spring acts to force the jaws 31, 33 apart so that they return to their initial configuration shown in FIG. 2, ready to receive an(other) identification tag 9 for applying to the ear of an animal.

A jaw sensor arrangement is provided in one or both of the upper jaw 31 and the lower jaw 33 to sense when the jaws 31, 33 have reopened following closing of the jaws 31, 33. The jaw sensor arrangement comprises a magnet and a sensor for sensing the magnet when it is in close proximity to the sensor, the sensor and the magnet being disposed so that they are brought into close proximity when the jaws 31, 33 are open but are not in close proximity when the jaws 31, 33 are closed. Thus, reopening of the jaws 31, 33 following operation of the jaws 31, 33 is detected by the sensor detecting that the magnet is proximal to the sensor.

An example of the positioning of the magnet and sensor is illustrated in FIG. 7, which is an enlarged view of the rear end of the upper jaw 31. As shown in FIG. 7, a magnet 63 is positioned on a rear surface of the jaw arm 51. A sensor 65 for sensing the magnet 63 is positioned on a housing of the applicator 1 so that the sensor 65 and magnet 63 are brought into close proximity when the jaws, 31, 33 are open. The sensor 65 is a hall-effect sensor. Of course, in another embodiment the positions of the sensor and magnet may be reversed. Thus, the sensor 65 is able to detect when the jaws 31, 33 have re-opened following actuation of the jaws 31, 33.

FIG. 7 also shows a spring 67 for biasing the jaws 31, 33 apart to an open configuration. The spring 67 is a compression spring between the jaw arm 51 and a part of the housing of the applicator 1 above the jaw arm 51 that is compressed when the jaw arm 51 is displaced upwards as the jaws 31, 33 are closed. Thus, when the jaw-closing cam 49 disengages from the jaw arm 51 after causing the pair of jaws 31, 33 to close the compressed spring 67 displaces the jaw arm 51 back downwards and thus causes the jaws 31, 33 to return to an open configuration, which is then detected by the sensor 65.

A controller is provided to stop operation of the jaw operator motor 43 when the sensor detects that the magnet is proximal to the sensor, i.e. that the jaws 31, 33 have re-opened following operation of the jaws 31, 33. Thus, once the jaw motor 43 has caused the jaws 31, 33 to close, and the jaws 31, 33 have subsequently re-opened, the jaw motor 43 is prevented from automatically re-closing the jaws 31, 33. The controller may be part of the sensor, part of the jaw operator motor 43, or a separate part of the applicator. For example, the controller may comprise an additional printed circuit board 53. Typically, the controller is a processor in wired communication with the jaw operator motor 43. The controller is configured to stop operation of the jaw operator motor 43 a predetermined time after the jaw sensor senses that the jaws 31, 33 have re-opened following closure. For example, the processor may comprise, or be connected to, a time keeping means for determining when a predetermined period of time has passed.

Of course, in other embodiments the same controller (or processor) may control operation of both the tag feed motor 25 and the jaw operator motor 43. In other words, the same processor may be in communication with both the tag feed motor 25 and the jaw operator motor 43 and configured to control operation of both of these motors.

As shown in FIG. 1, the applicator 1 comprises a power source in the form of a battery pack 55 for supplying power to any components of the applicator 1 that require a power supply, such as the tag feed motor 25, the jaw operator motor 43 and the various sensors 41 and printed circuit boards 39, 53.

The applicator 1 further comprises a trigger 57 that can be actuated by a user of the applicator 1 to start operation of the applicator 1. As discussed below, the trigger 57 is operatively connected to the jaw operator motor 43, for example directly or via a controller/processor, so that actuation of the trigger 57 causes the jaw operator motor 43 to start operation and to close the jaws 31, 33.

As shown in FIG. 1, the lower jaw 33 is integral with a lower jaw holder 59. Furthermore, the applicator 1 comprises covers 61 for enclosing the parts of the applicator 1.

Operation of the applicator 1 in use will now be described.

Firstly, a magazine 5 having a plurality of identification tags 9 in the channel 7 thereof is positioned in the guide channel 21 of the magazine guide 3. At this stage, no identification tag is present in the pair of jaws 31 to 33. A user of the applicator 1 then presses the trigger 57 to operate the applicator 1. When the trigger 57 is pressed, the jaw operator motor 43 is automatically started by a controller/processor operatively coupled to both the trigger 57 and the jaw operator motor 43. As described above, operation of the jaw operator motor 43 causes the pair of jaws 31, 33 to close, due to the interaction between the rotating jaw-closing cam 49 and the jaw-arm 51. The jaws 31, 33 are therefore forced to close against the biasing of the spring. However, since there is no identification tag 9 in the jaws 31, 33, no identification tag is applied at this time. As operation of the jaw operator motor 43 continues, the jaw-closing cam 49 disengages from the jaw arm 51 so that the jaws 31, 33 are no longer forced closed. Therefore, the jaws 31, 33 are forced open again by the action of the spring 67, which was compressed when the jaws 31, 33 were closed. Re-opening of the jaws 31, 33 is detected by the jaw sensor 65, and based on this detection the operation of the jaw operator motor 43 is automatically terminated by the controller processor a predetermined time after the detection, so that the jaws 31, 33 remain open and ready to receive an identification tag 9.

After a predetermined delay, operation of the tag feed motor 25 is automatically started by a controller/processor operatively coupled to the tag feed motor 25 and to the jaw operator motor 43 and/or the previously mentioned controller/processor. Of course, the same processor may be operatively coupled to both the tag feed motor 25 and to the jaw operator motor 43 for controlling operation of both of these motors. The tag pusher 23 is displaced within the channel 7 of the magazine 5 to displace the identification tags 9 in the channel 7 towards the dispensing opening 15 until the tag pusher 23 is adjacent to a first sensor 41 of the printed circuit board 39, which corresponds to the displacement necessary for a first identification tag 9 to be dispensed through the opening 15 and received by the jaws 31, 33. Operation of the tag feed motor is automatically stopped when the sensor 41 detects that the tag pusher 23 is adjacent to (above) the sensor 41. Thus, at this stage a single identification tag 9 has been dispensed to the pair of jaws 31, 33 and the tag feed motor 25 has been stopped so that the identification tags 9 are no longer being displaced.

The applicator 1 is now ready to apply an identification tag 9 to the ear of an animal. When the user actuates the trigger 57 again, the same operation of the jaws 31, 33 as described above happens again, except this time there is an identification tag 9 in the jaws 31, 33 and this identification tag 9 is applied to the ear of an animal positioned between the jaws 31, 33. The remainder of the operation is as described above, i.e. the jaws 31, 33 automatically open again, this is detected, and a predetermined time later the tag feed motor 25 is automatically started to dispense a further single identification tag 9 to the jaws 31, 33, ready to apply the further identification tag 9 to an ear of an animal.

Thus, by repeating this operation, a plurality of identification tags 9 (which may be different types) can be sequentially applied to ears of animals.

Once all of the identification tags 9 in the channel 7 have been dispensed, the tag feed motor 25 can be operated in reverse to take the tag pusher 23 back to its initial position at the rear end of the magazine 5 so that the empty magazine 5 can be removed and replaced with a fresh one. This operation may happen automatically, for example when a sensor indicates that there are no identification tags 9 remaining in the magazine 5, or that the tag pusher 23 has moved a sufficient distance to dispense all of the identification tags 9. Alternatively, this operation may be manually caused by the user actuating the trigger 57 when the tag pusher 23 has reached the end of the magazine 5.

Of course, other embodiments may differ from this embodiment. For example, in other embodiments the operation of the jaws 31, 33 may not be motorised, i.e. the jaw operator motor 43 and corresponding parts be omitted. Instead, the jaws 31, 33 may be operated manually, for example by the user squeezing a trigger that is directly coupled to the jaws 31, 33 to cause them to close.

Where the jaws 31, 33 are motorised, the mechanism by which the jaws 31, 33 are caused to close may be different to the worm, worm-wheel and jaw-closing cam arrangement described above.

In other embodiments only a single controller/processor or printed circuit board may be provided for controlling all of the parts of the applicator.

In other embodiments a different mechanism may be used to couple the tag feed motor to the tag pusher. For example, the tag pusher may be integral with a piston that is caused to extend or retract along a length of the tag magazine guide.

In other embodiments the sensors may be different to the sensors 41 described above. For example, there may be only one sensor that can measure displacement of the tag pusher or identification tags along the entire length of the tag magazine guide. Or the sensors may detect something other than a magnet, such as the presence or absence of some kind of electromagnetic radiation.

1. An applicator for animal identification tags comprising:
a tag magazine receiver configured to receive a tag magazine, the tag magazine comprising a reservoir for holding a plurality of discrete animal identification tags, each comprising a male and female engagement portion, and an opening, wherein the identification tags are displaceable along the reservoir to be sequentially dispensed through the opening;
a pair of jaws arranged to receive an identification tag dispensed from the opening of a received tag magazine, wherein the pair of jaws are operable to engage the male and female portions of the identification tag through the ear of an animal placed between the jaws;
a motorised tag dispenser operable to displace the identification tags along the reservoir of a received tag magazine to sequentially dispense the identification tags through the opening of the received tag magazine;
a sensor for sensing information indicative that an identification tag has been dispensed through the opening of the received tag magazine and received by the pair of jaws; and
a controller configured to stop operation of the motorised tag dispenser based on an output of the sensor.

2. The applicator according to claim 1, wherein the sensor is for sensing information indicative of the displacement of the identification tags along the reservoir of the received tag magazine.

3. The applicator according to claim 1, wherein the motorised tag dispenser comprises:
a pusher arranged to be received in the reservoir of a received tag magazine, the pusher being displaceable along the reservoir to push the identification tags along the reservoir; and
a tag dispenser motor operable to displace the pusher along the reservoir.

4. The applicator according to claim 3, wherein:
the motorised tag dispenser further comprises a lead-screw;
the tag dispenser motor is arranged to rotate the lead-screw; and
the pusher is coupled to the lead-screw so that rotation of the lead-screw causes displacement of the pusher along the reservoir.

5. The applicator according to claim 3, wherein the sensor is configured to sense a displacement of the pusher.

6. The applicator according to claim 3, wherein the sensor is configured to sense a position of the pusher.

7. The applicator according to claim 1, wherein the tag magazine receiver comprises an elongate member configured to receive the tag magazine.

8. The applicator according to claim 7, wherein the elongate member comprises a channel for receiving the tag magazine therein.

9. The applicator according to claim 7, wherein the applicator comprises a plurality of sensors, for sensing information indicative that an identification tag has been dispensed through the opening of the received tag magazine and received by the pair of jaws, arranged along an elongate length of the elongate member.

10. The applicator according to claim 1, wherein the applicator comprises a plurality of sensors, for sensing information indicative that an identification tag has been dispensed through the opening of the received tag magazine and received by the pair of jaws, disposed so as to be arranged along a length of the reservoir of a received tag magazine.

11. The applicator according to claim 9, wherein the sensors are arranged at a predetermined spacing that is equal to a necessary displacement of the identification tags to dispense an identification tag from the opening of the received tag magazine so that it is received by the pair of jaws.

12. The applicator according to claim 9,
wherein the motorised tag dispenser comprises:
a pusher arranged to be received in the reservoir of a received tag magazine, the pusher being displaceable along the reservoir to push the identification tags along the reservoir; and
a tag dispenser motor operable to displace the pusher along the reservoir, and
wherein each of the sensors is configured to detect when the pusher is proximal to the sensor.

13. The applicator according to claim 12, wherein the pusher comprises a magnet and the sensors are configured to detect the magnet when the pusher is proximal to the sensor.

14. The applicator according to claim 12, wherein the controller is configured to stop operation of the motorised tag dispenser when one of the sensors detects that the pusher is proximal to the sensor.

15. The applicator according to claim 1, wherein the applicator comprises a motorised jaw operator for operating the pair of jaws to engage the male and female portions of the identification tag through the ear of an animal placed between the jaws.

16. The applicator according to claim 15, wherein the applicator comprises a jaw sensor for sensing information indicative that the pair of jaws has been operated to engage the male and female portions of the identification tag through the ear of an animal placed between the jaws.

17. The applicator according to claim 16, wherein the jaw sensor is configured to sense when the pair of jaws have re-opened following being closed.

18. The applicator according to claim 16, wherein the applicator comprises a controller configured to stop operation of the motorised jaw operator based on an output of the jaw sensor.

19. The applicator according to claim 18, wherein the jaw sensor comprises a magnetically energised sensor for sensing when a magnet is proximal to the sensor.

20. The applicator according to claim 19, wherein:
one of the pair of jaws has a magnet; and
the jaw sensor is positioned on a housing of the applicator so that the magnet and the jaw sensor are brought into proximity when the pair of jaws are open.

21. The applicator according to claim 15, wherein the motorised jaw operator comprises:
a rotatable cam arranged to engage with an arm of one of the pair of jaws to force the pair of jaws to close as the cam is rotated, and to disengage from the arm upon further rotation of the cam; and
a jaw operator motor operatively coupled to the rotatable cam and operable to rotate the cam.

22. The applicator according to claim 15, wherein the applicator comprises a trigger for causing the motorised jaw operator to operate the pair of jaws when the trigger is actuated by a user of the applicator.

23. The applicator according to claim 15, wherein the motorised tag dispenser is configured to start operation after an end of operation of the motorised jaw operator.

24. The applicator according to claim 23, wherein the motorised tag dispenser is configured to start operation a predetermined time after an end of operation of the motorised jaw operator.

25. The applicator according to claim 1, wherein the pair of jaws are biased apart.

26. The applicator according to claim 3, wherein the controller is configured to operate the tag dispenser motor to displace the pusher back to an initial position when all of the identification tags have been dispensed from the opening of a received tag magazine.

27. An applicator system for animal identification tags, comprising:
an applicator according to claim 1; and
a tag magazine,
wherein the tag magazine comprises a reservoir for holding a plurality of discrete animal identification tags, each comprising a male and female engagement portion, and an opening,
wherein the identification tags are displaceable along the reservoir to be sequentially dispensed through the opening.

28. The applicator system according to claim 27, wherein the tag magazine is received by the tag magazine receiver with the opening adjacent the pair of jaws.

29. The applicator system according to claim 27, wherein the tag magazine is loaded with plural discrete identification tags.

30. The applicator system according to claim 27, wherein the reservoir comprises a channel.
